(19) United States
(12) Patent Application Publication
(10) Pub. No.: US 2021/0195905 A1
(43) Pub. Date: Jul. 1, 2021

(54) NATURAL COMPLEX PRESERVATIVE AGENT FOR GRAIN OR GRAIN PRODUCT

(71) Applicant: BST Inc., Seongnam-si (KR)

(72) Inventors: Ho LEE, Seongnam-si (KR); Chul KIM, Suwon-si (KR); Kyung Hyun IM, Suwon-si (KR)

(21) Appl. No.: 16/730,071

(22) Filed: Dec. 30, 2019

(51) Int. Cl. A23B 9/28

(52) U.S. Cl. CPC A23B 9/28

(57) ABSTRACT

Provided is a natural complex preservative agent for a grain or grain-based product. The preservative agent contains 50 wt % or greater of a Cordyceps extract and a broccoli extract, wherein the Cordyceps extract and broccoli extract are conjugated.

### TECHNICAL FIELD

The present disclosure relates to a natural complex preservative agent for a grain or a grain-based product. More specifically, the present disclosure relates to a natural complex preservative agent for a grain or a grain-based product based on Cordyceps and broccoli extracts.

### BACKGROUND ART

Due to the change in dietary patterns according to industrial development, the demand for alternative foods that may be easily eaten from children to adults is increasing. Grain-based foods as alternative foods include bread, rice cakes, noodles, cereals or similar products produced using grains. Such foods have been used as snacks, but gradually become a simple product that may replace the staple food in accordance with changes in the living environment. As the consumption of the grain-based products increases, a variety of products are being developed and released to actively reflect consumer tastes. However, most grain-based products have a disadvantage in that it is difficult to secure safety thereof against microorganisms because of their high moisture contents and easy growth of microorganisms therein. For example, microorganisms such as E. coli Bacillus cereus and Salmonella spp. which are widely distributed in the grain-based products may cause food poisoning and may be introduced in various pathways such as raw materials, production, packaging, or distribution. Although synthetic preservative agents have been used since the 1930s to address the risks to microorganisms, there may always be safety concerns thereof. In order to solve this problem, microbial control such as process improvement is being performed. However, a quality problem of the grain-based products or consequent disease accidents caused by microorganisms occurs. Research is underway on chitosan, natural extracts, microbial metabolites, organic acids or similar antibacterial materials that replace the synthetic preservative agents. However, despite such research and development, there are many difficulties in the production of preservative agents with effects such as securing the safety of the grain-based products and extending the storage period against the microorganisms. Korean Patent Application Publication No. 10-2016-0141605 discloses a method for preparing a natural preservative containing a rosemary composition. Further, International Publication No. WO 2017/083363 discloses a natural preservative agent derived from extracts of Albizia amara seeds and Magnolia officinalis bark, which may be used for the preservation of foods, cosmetics, nutrients, oral hygiene products and pharmaceuticals. The natural preservative agents need to be added to the grain or grain-based products with antibacterial effects against a variety of microorganisms so that the inherent properties of the grain or grain-based products are maintained or enhanced. However, the prior arts fail to disclose natural preservative agents having such characteristics.

The present disclosure is to solve the problems of the prior art and has following purposes.

### DISCLOSURE

### Technical Problem

An object of the present disclosure is to provide a natural complex preservative agent for grains or grain-based products, the agent containing a Cordyceps extract and a broccoli extract, to achieve improved antibacterial and preservative properties.

### Technical Solution

According to an appropriate embodiment of the present disclosure, a preservative agent for a grain or grain-based product contain 50 wt % or greater of a Cordyceps extract and a broccoli extract, in which the Cordyceps extract and broccoli extract are conjugated.

According to another appropriate embodiment of the present disclosure, the preservative agent contains at least one ingredient selected from the group consisting of a garlic extract, a green tea extract, a citrus junos extract, a cockscomb flower extract, a dandelion anulus extract, a lactic acid bacteria culture medium, a yeast culture medium, a licorice extract, a scutellariae radix extract, and a turmeric extract.

According to still another appropriate embodiment of the present disclosure, a microorganism for the conjugation includes Saccharomyces sp. or Lactobacillus Plantarum.

### Advantageous Effects

The natural complex preservative agent for the grain or grain-based products according to the present disclosure is composed of the Cordyceps extract and broccoli extract and may have high antibacterial properties against various microorganisms or molds. According to the present disclosure, the preservative agent may contain the garlic or green tea extract to improve antioxidant activity, thereby improving the growth inhibitory effect of the bacteria, yeast or mold. In accordance with the present disclosure, the grains or grain-based products are treated with the antibacterial agents to maintain their inherent properties while at the same time extending their quality maintaining periods. The antibacterial preparations according to the present disclosure may be applied to various foods.

### DESCRIPTION OF DRAWINGS

FIG. 1 shows an example of a production process of a natural complex preservative agent for grains or grain-based products according to the present disclosure.

FIG. 2 shows changes of components due to conjugation during the preparation of the preservative agent according to the present disclosure.

FIG. 3 shows results of an antioxidant effect when the preservative agent is applied to the grain-based products according to the present disclosure.

<Explanation of Reference Numerals and Symbols>

| | |
|---|---|
| P11: Cordyceps Growth | P12: Broccoli Crushing |
| P21, P22: Ingredient extraction | P30: Mixing |
| P40: Conjugation | |

### BEST MODE

In a following description, the present disclosure is described in detail with reference to the embodiments presented in the accompanying drawings. However, the embodiments are provided for clarity of understanding of the present disclosure, and the present disclosure is not limited thereto. In the following description, components having the same reference numerals in different drawings have similar functions and thus will not be repeated unless necessary for an understanding of the present disclosure. Well-known elements are briefly described or omitted, but should not be understood as being excluded from the embodiment of the present disclosure.

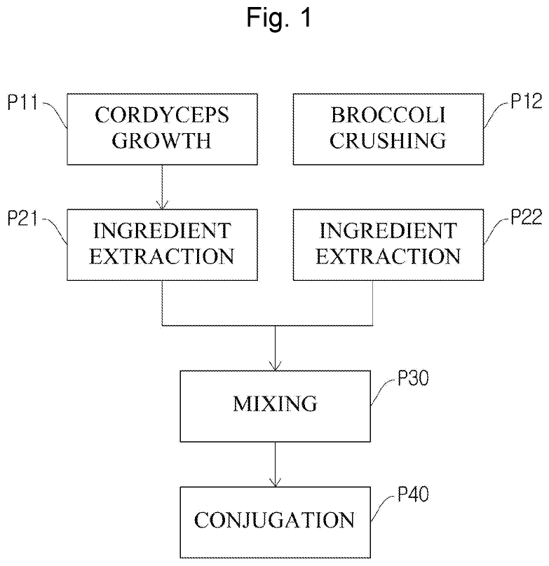

FIG. 1 shows an example of a production process of a natural complex preservative agent for grains or grain-based products according to the present disclosure.

The natural complex preservative agent for the grains or grain-based products according to the present disclosure may contain 50 wt % or greater of a Cordyceps extract and a broccoli extract. Cordyceps and broccoli may be prepared for the preparation of such a complex preservative agent (P11 and P12). Cordyceps may employ Cordyceps militaris, C. sobolifera, C. sphecocephala or similar Cordyceps. Cordyceps may be cultured under defined conditions for preservative agents according to the present disclosure, for example in liquid media, solid media or fillings (P11). Cordyceps may be cultured in a medium containing brown rice, potatoes, corn or similar grains, and culturing conditions may be established to increase the content of cordycepin. In the culture medium containing brown rice, the content of the cordycepin was changed according to the growth conditions. The content change is as listed in Table 1A to 1C.

TABLE 1A
<Comparisons of Growth Rate and Contents
According to Cultivation Temperature>

| | | | Dry Weight of | Cordycepin | |
|---|---|---|---|---|---|
| Sample | Condition | Length(mm) | Fruit Body(g) | Content(%) | Remarks |
| #01 | 10.0 ± 0.2° C. | 45 | 3.6 | 470 | |
| #02 | 12.0 ± 0.2° C. | 64 | 4.6 | 684 | |
| #03 | 14.0 ± 0.2° C. | 85 | 6.0 | 680 | |
| #04 | 16.0 ± 0.2° C. | 97 | 6.4 | 720 | |
| #05 | 18.0 ± 0.2° C. | 100 | 6.9 | 780 | |
| #06 | 20.0 ± 0.2° C. | 102 | 6.9 | 718 | |
| #07 | 21.0 ± 0.2° C. | 86 | 6.1 | 684 | |

TABLE 1B
<Comparisons of Growth Rate and Contents According to Cultivation Humidity>

| | | | Dry Weight of | Cordycepin | |
|---|---|---|---|---|---|
| Sample | Condition | Length(mm) | Fruit Body(g) | Content(%) | Remarks |
| #08 | 70.0% | 76 | 5.2 | 712 | |
| #09 | 75.0% | 85 | 5.7 | 705 | |
| #10 | 80.0% | 88 | 6.2 | 718 | |
| #11 | 85.0% | 92 | 6.5 | 740 | |
| #12 | 90.0% | 102 | 6.9 | 780 | |
| #13 | 95.0% | 104 | 6.9 | 718 | |

TABLE 1C
<Comparisons of Growth Rate and Contents According
to Cultivation light intensity (Lux)>

| | | | | Dry Weight of | Cordycepin | |
|---|---|---|---|---|---|---|
| Sample | Condition | | Length(mm) | Fruit Body(g) | Content(%) | Remarks |
| #14 | 200 | Lux | 98 | 6.7 | 524 | |
| #15 | 500 | Lux | 97 | 6.6 | 550 | |
| #16 | 1,000 | Lux | 101 | 6.8 | 650 | |
| #17 | 1,500 | Lux | 99 | 6.4 | 731 | |
| #18 | 2,000 | Lux | 102 | 6.9 | 780 | |

As may be seen from Tables 1A, 1B, and 1C, when the culturing temperature is 10 to 18° C., the content of cordycepin was increased as the growth rate was increased as the culturing temperature was increased. When the temperature is higher than 18° C., while the growth rate is reduced and thus the content of cordycepin was reduced. Further, as the humidity increased gradually to 90%, the content of cordycepin increased with increasing the growth rate. However, when the humidity exceeds 90%, it turns out to be rather disadvantageous. Regarding the light intensity, the growth rate remained constant in a range of 200 to 2,000 Lux. However, the content of cordycepin was increased with increasing the light intensity. Therefore, Cordyceps is advantageously cultured at a temperature of 10 to 18° C., a relative humidity below 90% and the light intensity of 200 to 2,000 Lux. Broccoli may be crushed after drying to form a powder (P12). For example, broccoli may be dried to a moisture content of 10 wt % or smaller and crushed to a size of 200 mesh or smaller (P12). When Cordyceps and broccoli are prepared in this way, each of the active ingredients thereof may be extracted (P21, P22). Extraction of Cordyceps and broccoli may be accomplished in a variety of ways. For example, the active ingredient may be extracted by hydrothermal extraction, microwave extraction or supercritical extraction. Broccoli may vary in an extraction yield and antibacterial activity depending on the extraction conditions. Therefore, it is advantageous to extract the broccoli according to the appropriate extraction conditions. Table 2 shows the extraction conditions of the broccoli, and accordingly the extraction yield and antibacterial activity.

TABLE 2
<Yield and antibacterial activity based on extraction conditions of broccoli>

| | Extraction | | Extraction | | Other | Extraction | Antibacterial |
|---|---|---|---|---|---|---|---|
| Sample | Temperature | | Time | | Treatment | Yield¹⁾ | Activity²⁾ |
| #01 | 4° | C. | 3 | day | — | 524 | |
| #02 | 4° | C. | 7 | day | — | 550 | |
| #03 | 4° | C. | 3 | day | Still for 6 hours | 650 | |
| | | | | | after the crushing | | |
| #04 | 4° | C. | 7 | day | Still for 6 hours | 731 | |
| | | | | | after the crushing | | |
| #05 | 60° | C. | 4 | h | — | 780 | |
| #06 | 60° | C. | 8 | h | — | | |
| #07 | 60° | C. | 4 | h | Still for 6 hours | | |
| | | | | | after the crushing | | |
| #08 | 60° | C. | 8 | h | Still for 6 hours | | |
| | | | | | after the crushing | | |
| #09 | 80° | C. | 4 | h | Still for 6 hours | | |
| | | | | | after the crushing | | |
| #10 | 80° | C. | 8 | h | Still for 6 hours | | |
| | | | | | after the crushing | | |
| #11 | 120° | C. | 4 | h | Still for 6 hours | | |
| | | | | | after the crushing | | |
| #12 | 120° | C. | 8 | h | Still for 6 hours | | |
| | | | | | after the crushing | | |
| #13 | 120° | C. | 8 | h | Still for 12 hours | | |
| | | | | | after the crushing | | |
| #14 | 120° | C. | 8 | h | Still for 24 hours | | |
| | | | | | after the crushing | | |
| #15 | 120° | C. | 8 | h | Still for 48 hours | | |
| | | | | | after the crushing | | |

++++: 10 mm or greater,
+++: 7 mm or greater,
++: 3 mm or greater,
±: smaller than mm,
—: unidentifiable
¹⁾extraction yield: dry reduced weight after extraction/raw material weight used for extraction * 100
²⁾antibacterial activity: comparison of clear zone by bio assay (mm)

As may be seen from Table 2, the yield or antibacterial activity increases with the extraction temperature or extraction time, and the effect of the temperature is greater than that of the time. However, when 24 hours has lapsed after crushing, antibacterial activity was decreased. Further, it is advantageous to leave the broccoli still for 6 hours after the crushing and then to extract the broccoli. This is due to a fact that the extraction efficiency may increase due to the tissue softening by enzymatic reaction in broccoli after the crushing.

The cordyceps extract and broccoli extract may be mixed with each other (P30). Then, the extracts may be conjugated using microorganisms Saccharomyces cerevisiae (KCTC 7296), Lactobacillus plantarum subsp. such as plantarum (KCTC 3108) and Weissella cibaria (KCTC 3807). The antibacterial activity according to the mixing ratio and the type of the microorganism is presented in Table 3.

TABLE 3
<Antibacterial activity according to mixing ratio and conjugation>

| | Cordyceps | Broccoli | Conjugation | Antibacterial | |
|---|---|---|---|---|---|
| Sample | Extract | Extract | (Biotransformation) | Activity¹⁾ | Remarks |
| Group 1 | 100 | 0 | — | ++ | |
| | 100 | 0 | S/L²⁾ | +++ | |
| | 100 | 0 | S/W²⁾ | ++ | |
| | 75 | 25 | — | ++ | |
| | 75 | 25 | S/L | ++++ | Bio³⁾ |
| | 75 | 25 | S/L | +++++ | Con⁴⁾ |
| | 75 | 25 | S/W | +++ | Con |
| Group 2 | 50 | 50 | — | ++ | |
| | 50 | 50 | S/L | +++ | Bio |
| | 50 | 50 | S/L | ++++ | Con |
| | 50 | 50 | S/W | +++ | Con |
| Group 3 | 25 | 75 | — | + | |
| | 25 | 75 | S/L | ++ | Bio |
| | 25 | 75 | S/L | +++ | Con |
| | 25 | 75 | S/W | +++ | Con |
| | 0 | 100 | — | + | |
| | 0 | 100 | S/L | ++ | |
| | 0 | 100 | S/W | ++ | |

¹⁾The more +, the better the antibacterial activity (++++: clear zone 10 mm or greater and MIC Value 1.0% or smaller)
²⁾S; Saccharomyces sp., L: Lactobacillus Plantarum, W: Weissella cibaria
³⁾Bio; each bioconversion → Mix
⁴⁾Con; Mix → bioconversion = Conjugation

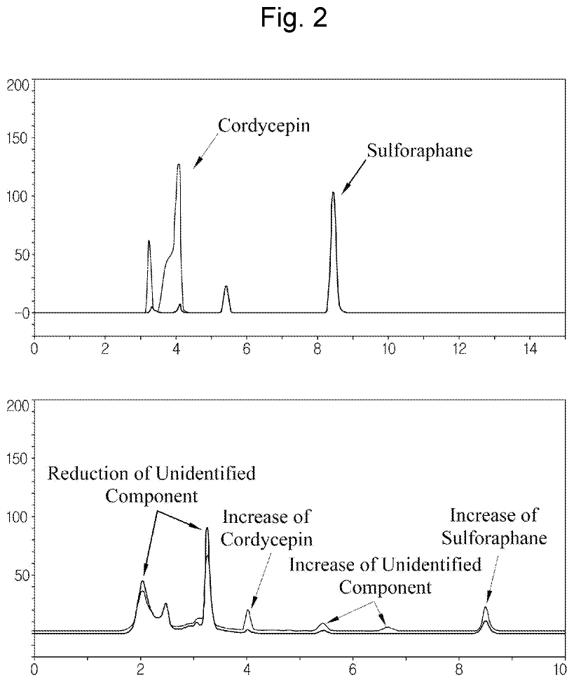

As may be seen from Table 3, the antibacterial activity is increased when the content of the Cordyceps extract is 50 wt % or greater. Further, the antibacterial activity is increased when the conjugation is made using a mixture of Saccharomyces sp. and Lactobacillus Plantarum. In order to check that the improvement in the antibacterial activity is due to the conjugation, the change of the component was identified using high-performance liquid chromatography (HPLC), and is shown in FIG. 2. An upper side of FIG. 2 shows the contents of Sulforaphane and Cordycepin, respectively, while a lower side thereof shows changes of the components after the conjugation. FIG. 2 shows the change of the components before and after the conjugation. As may be seen from FIG. 2, a new component appears as the amounts of the Cordycepin and Sulforaphane increase.

The conjugated preservative agent may be applied alone or in combination with other ingredients to become a natural preservative agent or freshener. According to one embodiment of the present disclosure, the preservative agent may contain a garlic extract, a green tea extract, a Citrus junos extract, a cockscomb flower extract, a Dandelion Anulus extract. Such extracts may be extracted by methods such as hydrothermal extraction, microwave extraction or supercritical extraction. Further, at least one of the extracts may be added to the preservative agent and may be added thereto before or after the conjugation. At least one selected from the group consisting of a garlic extract, green tea extract, Citrus junos extract, cockscomb flower extract, Dandelion Anulus extract, lactic acid bacteria culture medium, yeast culture medium, licorice extract, Scutellariae radix extract and Turmeric extract may be added to the agent in a content of 1 to 50 wt % with respect to a total weight of the preservative agent.

Antioxidant activity by the preservative agent according to the present disclosure was measured.

Antioxidant Activity Measurement

The radical scavenging activity was identified for the measurement of antioxidant activity, and this was performed using the modified free radical method. For accurate comparison, the preservative agent containing green tea extract was lyophilized and powdered. 0.2 mL of a sample obtained by dissolving the lyophilized preservative agent using MeOH in a varying concentration, and 1.8 mL of 0.2 mM 2,2-diphenyl-1-picrylhydrazyl (DPPH) solution were mixed with each other and the mixture was left in the dark site for 30 minutes. Absorbance was measured at 517 nm with a UV/Vis spectrophotometer. A concentration for 50% scavenging of radical (SC50) required to reduce the DPPH radicals by 50% was determined using the measured absorbance. L-ascorbic acid and BHA (Butylated Hydroxy Anisole) were used as positive controls.

Grain-Based Products Treated with Preservative Agent

Raw noodles and bread were selected as grain-based products for measurement, and were made with the ingredient compositions as Table 4. The raw noodles were made as follows: the salt-dissolved water and flour were into the kneader and then kneaded in 3 steps for 8 minutes, and then rested for 15 minutes in a refrigerator. After the resting was finished, the mixture was divided into noodle, each has a thickness of 2.5 mm and a width of 2 mm and having a weight of 100 g, using a noodle machine. The bread employed a mix product. After mixing enough water and yeast powder and inputting the mixture into the kneader bowl. The mixture powder was subdivided into several times. The dough was primary fermented at 25° C. for 30 minutes and secondary fermented at 25° C. for 120 minutes was baked in an oven preheated to 180° C. for 30 minutes and then cooled at room temperature for 30 minutes. The cooled bread was cut into 15 mm and subdivided to pieces, each having 200 g. The subdivided raw noodles and bread were sprayed with the preservative agent at a varying concentration, and the spraying amount was adjusted to 10% (w/w) or smaller. The sprayed foods were left standing at room temperature for 10 minutes and then packaged in sealed packs. Raw noodles were stored at 12° C. and bread at 25° C. respectively to observe changes thereof.

TABLE 4
<Grain-based product treated with preservative agent>

| Products | Ingredient | Weight(g) |
|---|---|---|
| Wet Noodle | Medium wheat Flour | 100 |
| | Salt | 3 |
| | Water | 40 |
| White pan bread | CJ inc. premix | 380 |
| | Water | 220 |

Microbiological Properties of Grain-Based Products

For microbiological analysis of grain-based products, 10 g of the sample and 100 mL of saline solution were placed into a sterilized sample bag and then homogenized for 120 seconds at 100 rpm using a stomacher. 1 mL of homogenized sample solution was diluted in a 10-1 ratio, and the total count of bacteria was plated on an aerobic count plate and was cultured at 37° C. for 24 to 72 hours to determine colony counts. We plated the sample on the yeast and mold count plate and cultured the sample at 25° C. for 72 to 120 hours. The total count of yeast and molds was counted to determine colony counts. The identified colony count was expressed as log cfu/g in terms of a dilution factor.

Statistical Analysis

The significance of the measurement results was expressed as average ±standard deviation with SPSS ver.20 software (IBM, Armonk, USA). The statistical significance was tested using Duncan's multiple range test (P<0.05).

Results and Discussion

Establishing of complex extract mixing ratio and fermentation condition

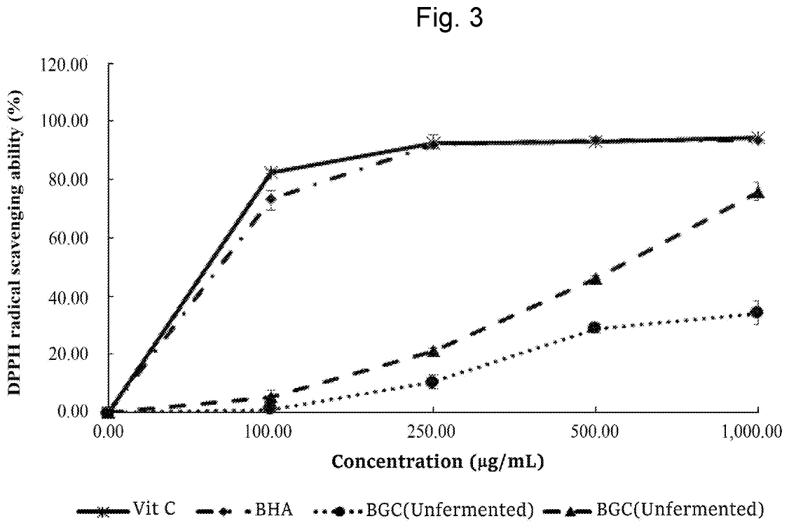

The mixing ratio and fermentation condition were checked. Then, the antibacterial activity was evaluated based on the clear zone and minimum inhibitory concentration (MIC) values. The best conditions were selected as listed in Table 5. The antibacterial activity of the complex extract before fermentation was relatively good when the Cordyceps extract was added in a content of 50% or greater. Cordyceps 75%/broccoli 25% complex extract (d) exhibited 5.7 mm (clear zone) and 1.5% (MIC vale). The strains used for fermentation were Saccharomyces cerevisiae, Lactobacillus plantarum, Weisella cibaria, and the mixed strain fermentation was used. At all mixing ratios, significant increase in antibacterial activity was observed upon fermentation using S/L (Saccharomyses cerevisiae & Lactobacillus plantarum). Cordyceps 75%/broccoli 25% complex extract (e) exhibited 10.1 mm and 0.89% antibacterial activity. Further, the antibacterial activities of the fermentations before and after mixing the Cordyceps extract and the broccoli extract were identified. When the extract mixture was fermented, the antibacterial activity was increased. A final screened condition was the Cordyceps 75%/broccoli 25% complex extract (g) as fermented using Saccharomyses cerevisiae and Lactobacillus plantarum exhibited a clear zone 14.3 mm and MIC 0.54%, which are excellent effects. The measurement effect is shown in FIG. 3.

TABLE 5
<Measurement of effect of preservative agents on grain-based products>

| | Cordyceps militaris | Broccoli | | Fermentation | ¹⁾Antibacterial |
|---|---|---|---|---|---|
| | extract | extract | Microorganisms | Time | activity |
| a | 100 | 0 | — | | ++ |
| b | 100 | 0 | ²⁾S/L | | +++ |
| c | 100 | 0 | ²⁾S/W | | ++ |
| d | 75 | 25 | — | | ++ |
| e | 75 | 25 | S/L | ³⁾F-M | ++++ |
| f | 75 | 25 | S/W | F-M | +++ |
| g | 75 | 25 | S/L | ³⁾M-F | +++++ |
| h | 75 | 25 | S/W | M-F | +++ |
| i | 50 | 50 | — | | ++ |
| j | 50 | 50 | S/L | F-M | +++ |
| k | 50 | 50 | S/W | F-M | +++ |
| l | 50 | 50 | S/L | M-F | ++++ |
| m | 50 | 50 | S/W | M-F | +++ |
| n | 25 | 75 | — | | + |
| o | 25 | 75 | S/L | F-M | ++ |
| p | 25 | 75 | S/W | F-M | ++ |
| q | 25 | 75 | S/L | M-F | +++ |
| r | 25 | 75 | S/W | M-F | +++ |
| s | 0 | 100 | — | | + |
| t | 0 | 100 | S/L | | ++ |
| u | 0 | 100 | S/W | | ++ |

¹⁾++++: clear zone more than 10 mm & MIC value less than 10%, +++: clear zone more than 10 mm, ++: clear zone more than 7 mm & MIC value less than 15% +: clear zone less than 7 mm, —: not detected of antibacterial activity
²⁾S: Saccharomyces cerevisiae, L: Lactobacillus plantarum subsp. plantarum, W: Weissella cibciria
³⁾F-M: Mix after fermentation, M-F: Fermentation after mix

Referring to the DPPH radical scavenging results in FIG. 2, the positive control and the sample both show a concentration dependency. In the positive control, to remove 50% of DPPH radical, concentrations of L-ascorbic acid and BHA were 49.95 μg/mL and 58.83 μg/mL, respectively. The concentration of the green tea-containing preservative agent was found to be 592.52 μg/mL. The green tea-containing preservative agent was lower in the antioxidant activity than the positive control and had a large antioxidant activity compared to 1,000 μg/mL which corresponds to the value of the preservative agent before conjugation.

Microbiological Characteristics of Grain-Based Products

Table 6 shows the microbiological characteristics of raw noodles treated with the green tea containing preservative agent.

TABLE 6
<Microbiological characteristics of raw noodles treated
with green tea-containing preservative agent (BGC)>

| | Concentration | Storage Time(days) | | |
|---|---|---|---|---|
| Microorganisms | (%) | 0 | 5 | 10 |
| Total Bacteria | Control(90% EtOH) | ¹⁾2.01 ± 0.49^{bA} | 6.21 ± 1.20^{aA} | 8.18 ± 0.93^{aA} |
| | BGC 0.100 | 1.96 ± 0.27^{bA} | 3.71 ± 0.36^{bB} | 6.22 ± 0.48^{aB} |
| | BGC 0.300 | 2.29 ± 0.81^{bA} | 2.78 ± 0.70^{aBBC} | 3.75 ± 0.12^{aC} |
| | BGC 0.500 | 1.71 ± 0.23^{aA} | 1.89 ± 0.24^{aC} | 2.13 ± 0.33^{aD} |
| Yeast/Mold | Control(90% EtOH) | 1.34 ± 0.39^{cbA} | 3.27 ± 1.48^{bA} | 5.69 ± 0.54^{aA} |
| | BGC 0.100 | 2.42 ± 0.46^{bA} | 3.51 ± 1.06^{bA} | 6.13 ± 0.87^{aA} |
| | BGC 0.300 | 1.98 ± 0.83^{bA} | 2.25 ± 0.52^{bBA} | 4.30 ± 0.13^{aAB} |
| | BGC 0.500 | 1.73 ± 0.27^{aA} | 1.47 ± 0.45^{aBC} | 0.96 ± 0.51^{aC} |

^{a-c}Small letter refer difference significants (PÂ005) in the same row by storage duration through Duncan TEST
^{A-D}Capital letter refer difference significants (PÂ005) in the same column by different concentration treatment through Duncan TEST

Referring to Table 6, in the 90% EtOH treated group, the initial total bacteria and yeast/mold counts were 2.01 log cfu/g and 1.34 log cfu/g, respectively, and then total bacteria and yeast/mold counts increased rapidly to 8.18 log cfu/g and 5.69 log cfu/g on day 10 of storage. The total bacteria count of the green tea containing preservative agent 0.1% treated group was 3.71 log cfu/g on the 5th day of storage, and increased to 6.22 log cfu/g on the 10th day of storage and was found to inhibit the growth of microorganisms. Further, the growth control of the yeast/mold thereof was identified to be not significantly different from that of the 90% EtOH treatment. The total bacteria count of the green tea containing preservative agent 0.3% treated group was 3.75 log cfu/g on the 10th day of storage and inhibited the growth thereof Although growth of yeast/mold was inhibited until day 5 of storage, the total bacteria count sharply increases to 4.30 log cfu/g on day 10 of storage. The green tea containing preservative agent 0.5% treated group exhibited a total bacterial count 2.13 log cfu/g and a total yeast/mold count 0.96 log cfu/g on day 10 of the storage and was found to inhibit the growth of microorganisms. In particular, in case of yeast/mold, the number of microorganisms was found to decrease from the initial 1.73 log cfu/g to 0.96 log cfu/g.

TABLE 7
<Microbiological Characteristics of Bread Treated with
Green Tea Containing Preservative Agent (BCG)>

| | Concentration | Storage Time(days) | | |
|---|---|---|---|---|
| Microorganisms | (%) | 0 | 5 | 10 |
| Total Bacteria | Control(90% EtOH) | 0.32 ± 0.03^{cA} | 2.11 ± 0.77^{bA} | 5.32 ± 1.01^{aA} |
| | BGC 0.300 | 0.33 ± 0.10^{bA} | 2.06 ± 0.05^{bA} | 4.72 ± 0.42^{aA} |
| | BGC 0.500 | 0.42 ± 0.11^{bA} | 1.11 ± 0.60^{bAB} | 3.01 ± 0.33^{aA} |
| | BGC 0.800 | 0.48 ± 0.23^{aA} | 0.81 ± 0.23^{aBC} | 1.32 ± 0.28^{aB} |
| Yeast/Mold | Control(90% EtOH) | 0.22 ± 0.07^{bA} | 1.31 ± 0.51^{bA} | 4.62 ± 0.90^{aA} |
| | BGC 0.300 | 0.32 ± 0.14^{bA} | 1.73 ± 1.03^{bA} | 4.37 ± 0.88^{aA} |
| | BGC 0.500 | 0.23 ± 0.10^{cA} | 2.21 ± 0.37^{bA} | 3.37 ± 1.07^{aA} |
| | BGC 0.800 | 0.17 ± 0.31^{aA} | 0.42 ± 0.03^{aB} | 0.81 ± 1.31^{aAB} |

^{a-c}Small letter refer difference significants (PÂ005) in the same row by storage duration through Duncan TEST
^{A-D}Capital letter refer difference significants (PÂ005) in the same column by different concentration treatment through Duncan TEST

Table 7 shows the microbial characteristics of bread treated with the green tea containing preservative agent. The initial total bacteria and yeast/mold counts were identified as 0.32 log cfu/g and 0.22 log cfu/g, respectively. However, on day 10 of storage, the values increased to 5.32 log cfu/g and 4.62 log cfu/g. In the treated group with the green tea containing preservative agent, the initial bacteria count was similar to that of the 90% EtOH treated group. The preservative agent 0.3% treated group showed 4.72 log cfu/g, and 4.37 log cfu/g on day 10 of storage while BGC 0.5% treated group showed 3.01 log cfu/g, and 3.37 log cfu/g on day 10 of storage. In particular, in the preservative agent 0.8% treated group, the total bacteria and yeast/mold counts were 1.32 log cfu/g and 0.81 log cfu/g respectively. The preservative agent 0.8% treated group exhibited the growth inhibition of 99.9% or more of the microorganisms compared to the 90% EtOH treated group.

Referring to the above measurement results, Cordyceps and broccoli extracts used in the natural complex antibacterial preparation are mixed in a 75:25 ratio. Using the mixture of Saccharomyces cerevisiae and Lactobacillus Plantarum subsp. plantarum was most effective in antibacterial activity, the extracts are conjugated. The antibacterial activity of the preservative agent exhibited the best antibacterial activity which corresponds to Clear zone 14.3 mm, and MIC value 0.54%. Further, the antioxidant activity of the preservative agent mixed with the garlic and green tea extracts shows a concentration (RC50) to remove 50% of the DPPH radicals being 592.52 μg/mL, which is slightly higher than that in the positive control L-Ascorbic acid and BHA and may be improved by the conjugation. When the grain-based product is treated with the preservative agent, growth of total bacteria and yeast/mold therein is inhibited. For example, for raw noodles, growth inhibitory activity of microorganisms may be identified when the raw noodle is treated with 0.3% or greater of the preservative agent. In particular, when the raw noodle is treated with BGC 0.5%, the growth inhibition is achieved to be the total bacteria 2.13 log cfu/g and the total yeast/mold 1.01 log cfu/g. In the bread, growth was inhibited by the significant difference in the total bacteria and yeast/mold counts when the bread is treatment with 0.5% or more of preservative agent. In particular, when the bread is treated with 0.8% preservative agent, the total bacteria count is 1.32 log cfu/g and the yeast/mold count is 0.81 log cfu/g and thus inhibited 99.9% or more thereof compared to the 90% EtOH treated group. Various components are mixed with the Cordyceps extract and broccoli extract and are conjugated. Thus, a resulting product is used as a preservative agent applicable to various kinds of grains or grain-based products, and the presented embodiments is not limited thereto.

The natural complex preservative agent for the grain or grain-based products according to the present disclosure is composed of the Cordyceps extract and broccoli extract and may have high antibacterial properties against various microorganisms or molds. According to the present disclosure, the preservative agent may contain the garlic or green tea extract to improve antioxidant activity, thereby improving the growth inhibitory effect of the bacteria, yeast or mold. In accordance with the present disclosure, the grains or grain-based products are treated with the antibacterial agents to maintain their inherent properties while at the same time extending their quality maintaining periods. The antibacterial preparations according to the present disclosure may be applied to various foods.

Although the present disclosure has been described in detail above with reference to the presented embodiments, those skilled in the art may make various modifications and modifications without departing from the technical spirit of the present disclosure with reference to the presented embodiments. The present disclosure is not limited by these embodiments, but rather by the claims appended hereto.

1. A preservative agent for a grain or grain-based product containing 50 wt % or greater of a Cordyceps extract and a broccoli extract, wherein the Cordyceps extract and broccoli extract are conjugated.

2. The preservative agent of claim 1, wherein the agent contains at least one ingredient selected from the group consisting of a garlic extract, a green tea extract, a citrus junos extract, a cockscomb flower extract, a dandelion anulus extract, a lactic acid bacteria culture medium, a yeast culture medium, a licorice extract, a scutellariae radix extract, and a turmeric extract.

3. The preservative agent of claim 1, wherein a microorganism for the conjugation includes Saccharomyces sp. or Lactobacillus Plantarum.
